(19) United States
(12) Patent Application Publication
(10) Pub. No.: US 2014/0160008 A1
(43) Pub. Date: Jun. 12, 2014

(54) OPTICAL INPUT DEVICE AND OPERATING METHOD THEREOF

(71) Applicant: LITE-ON IT CORPORATION, Taipei (TW)

(72) Inventor: Hua-De LEI, Hsinchu (TW)

(21) Appl. No.: 13/912,527

(22) Filed: Jun. 7, 2013

(30) Foreign Application Priority Data
Dec. 10, 2012 (CN) 201210527979.9

(51) Int. Cl. G06F 3/01

(52) U.S. Cl. CPC G06F 3/011
USPC 345/156

(57) ABSTRACT

An optical input device includes a light source module, a scan unit, a detection unit and a processing unit. The light source module generates a detection beam. The scan unit drives the detection beam to scan multiple frames in an input detection space. When scanning the frames, the detection unit detects a reflected detection beam and outputs a corresponding detection signal. The processing unit generates a process result corresponding to each of the frames according to the detection signal, generates an operation instruction according to the process results, and outputs the operation instruction to a peripheral device to execute the operation instruction.

This application claims the benefit of People's Republic of China application Serial No. 201210527979.9, filed Dec. 10, 2012, the subject matter of which is incorporated herein by reference.

### BACKGROUND OF THE INVENTION

1. Field of the Invention

The invention relates in general to an input device, particularly, to an input device utilizing optical detection and an operating method thereof.

2. Description of the Related Art

Accompanied with advancements in technologies, common conventional input devices such as keyboards, mouse devices and operating keys are gradually replaced by touch input devices. For example, touch screens prevail in various electronic products including mobile handsets, satellite navigation systems, digital cameras, video cameras and portable pads, to allow a user to enter an instruction by directly touching and selecting a desired point on the screen with a finger or a stylus. Thus, the electronic devices are made more compact and portable by employing the touch input device instead of the additional conventional input device. Moreover, the approach of directly selecting displayed contents on the screen through touch control provides a user with more intuitive operations.

However, the above touch input device still requires physical contacts for entering an instruction. Therefore, a remote input device is further developed to offer a user with even more convenient operations that are unbound by requirements of coming into contacts with an input device. For example, XBOX 350 Kinect somatosensory game consoles, launched by Microsoft, are capable of entering instructions without physical contacts.

In a current remote input device, operations are in principle performed through detections on user movements by utilizing a complementary metal oxide semiconductor (CMOS) optical sensor. An image frame of a user movement is captured by the CMOS optical sensor, and then undergoes an image recognition process. According to a result of the image recognition process, an intention represented by the user movement is determined to further generate a movement instruction for achieving an intended control operation. Nonetheless, computations involved in the image recognition process are extremely complicated, and a CMOS element employed for image capturing increases production costs while also keeping a volume of the remote input device irreducible.

### SUMMARY OF THE INVENTION

The invention is directed to an optical input device that generates process results corresponding to different scan frames after detecting a detection beam reflected from an input detection space. Thus, complicated image recognition processes can be eliminated to effectively reduce a response time of an operation input and significantly enhance operation instantaneity.

According to an aspect of the present invention, an optical input device is provided. The optical input device includes a light source module, a scan unit, a detection unit and a processing unit. The light source unit generates a detection beam. The scan unit drives the detection beam to scan a plurality of frames in an input detection space. When scanning at least two of the frames, the detection unit detects the detection beam reflected by an object in the input detection space and correspondingly outputs a detection signal. When scanning the at least two frames, the processing unit generates a process result respectively corresponding to the at least two frames, generates an operation instruction according to the process results corresponding to the at least two frames, and outputs the operation instruction to a peripheral device to execute the operation instruction.

According to another aspect of the present invention, an operating method of an optical input device is provided. The method includes steps of: driving a detection beam to scan a plurality of frames in an input detection space; when scanning a first frame, detecting a first reflected detection beam and correspondingly outputting a first detection signal, and generating a first process result according to the first detection signal; when scanning a second frame, detecting a second reflected detection beam and correspondingly outputting a second detection signal, and generating a second process result according to the second detection signal; generating an operation instruction according to the first and second process results; and outputting the operation instruction to a peripheral device to execute the operation instruction.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of an optical input device according to an embodiment of the present invention.

FIG. 2 is a flowchart of an operating method of an optical input device according to an embodiment of the present invention.

FIG. 3 is a schematic diagram of a schematic diagram illustrating a position of an object in an input detection space when scanning a first frame and a corresponding process result.

FIG. 4 is a schematic diagram of a schematic diagram illustrating a position of an object in an input detection space when scanning a second frame and a corresponding process result.

### DETAILED DESCRIPTION OF THE INVENTION

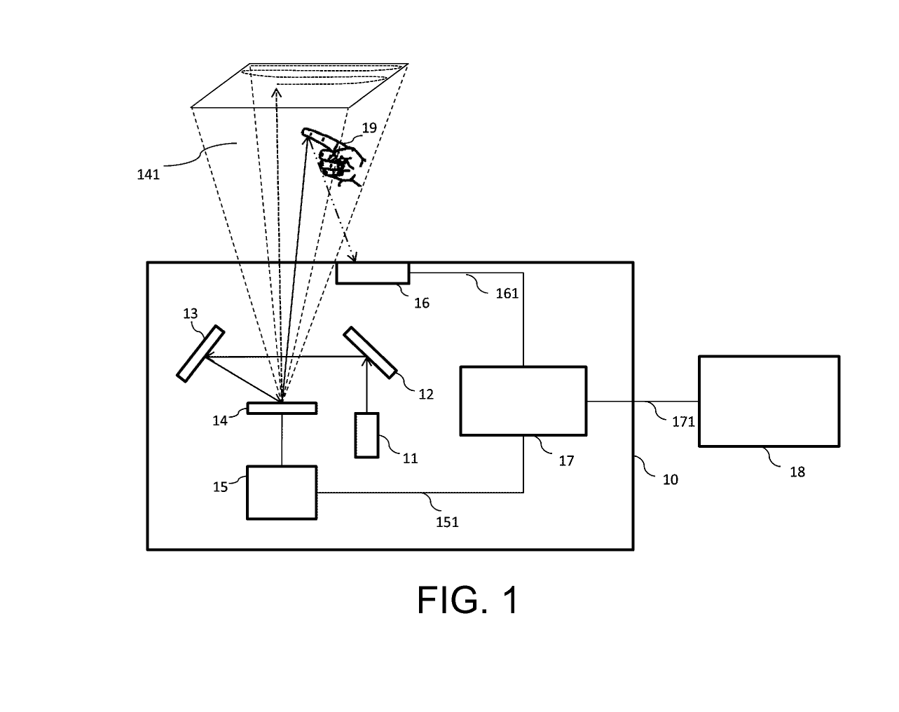

FIG. 1 shows a schematic diagram of an optical input device according to an embodiment of the present invention. An optical input device 10 includes a light source module 11, a plurality of optical elements 12 and 13, a scan unit 14, a scan control unit 15, a detection unit 16 and a processing unit 17. The light source module 11 generates a detection beam, which is projected onto the scan unit 14 after passing through the optical elements 12 and 13. In one embodiment, the light source module 11 may generate a detection beam having an invisible wavelength. In a preferred embodiment, the detection beam is an infrared beam having an invisible wavelength.

The scan unit 14 reflects and drives the detection beam to scan back-and-forth in an input detection space 141. The scan control unit 15 generates a control signal for controlling a swing angle of the scan unit 14 to control a scan position of the detection beam. The scan control unit 15 further outputs a position signal 151 corresponding to the swing angle of the scan unit 14 to the processing unit 17. For example, the position signal 151 corresponds to the scan position of the detection beam. In an embodiment, the scan unit 14 may be a two-dimensional MEMS scanning mirror, and the scan control unit 15 may control the scan unit 14 to scan back-and-forth through a raster scan, a Lissajous scan or another predetermined scan approach in the input detection space 141. A complete scan process performed by the detection beam driven by the scan unit 14 in the input detection space 141 may be defined as one complete scan process of one frame. The scan unit 14 then drives the detection beam to perform a next complete scan process in the input detection space 141, i.e., to scan a next frame.

During the scan process of the detection beam driven by the scan unit 14 in the input detection space 141, the detection unit 16 detects the detection beam reflected by an object 19 located in the input detection space 141, and correspondingly outputs a detection signal 161 to the processing unit 17. In an embodiment, the detection unit 16 may be an optical detector for converting the reflected detection beam detected to a detection signal 61 in a voltage form. In an embodiment, when the detection unit 16 detects the reflected detection beam, the detection unit 16 may correspondingly output a voltage pulse having an amplitude corresponding an intensity of the reflected detection beam. In other words, the amplitude of the voltage pulse and the intensity of the reflected detection beam are correlated by a ratio relationship. For example, the amplitude of the voltage pulse becomes greater as the intensity of the reflected detection beam gets higher. In an alternative embodiment, the detection unit 16 may also convert the reflected detection beam detected to a detection signal in a different form, e.g., to a current signal or a digital signal.

The processing unit 17 performs a signal process according to the received detection signal 161 and the corresponding position signal 151 to generate a process result. The processing unit 17 further converts the process result to an operation instruction 171, and outputs the operation instruction 171 to a peripheral device 18 to execute the operation instruction 171 on the peripheral device 18. In an embodiment of the present invention, the peripheral device 18 may be an electronic device such as a computer, a mobile handset or a television, and the processing unit 17 may output the operation instruction 171 to the peripheral device 18 via a transmission method such as a transmission line, infrared, WiFi wireless transmission or Bluetooth wireless transmission, so as to perform an operation control on the peripheral device 18.

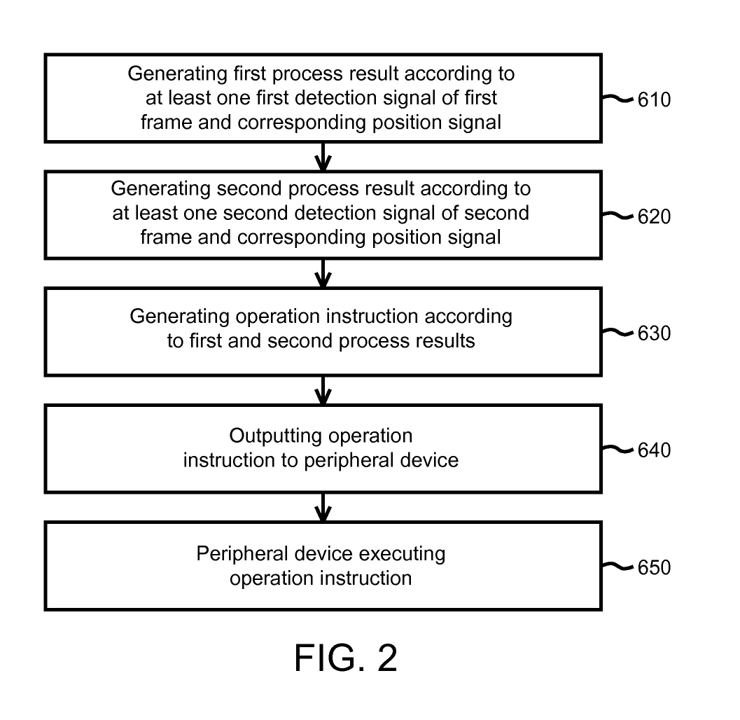

FIG. 2 shows a flowchart of an operating method of an optical input device according to an embodiment of the present invention. Referring to FIGS. 1 and 2, the operating method of an optical input device includes the following steps. In step 610, a first process result is generated according to at least one first detection signal corresponding to a first frame and a corresponding position signal. In step 620, a second process result is generated according to at least one second detection signal corresponding to a second frame and a corresponding position signal. In step 630, an operation instruction 171 is generated according to the first process result and the second process result. In step 640, the operation instruction 171 is outputted to a peripheral device 18. In step 650, the peripheral device 18 executes the operation instruction 171 to achieve operation control on the peripheral device 18.

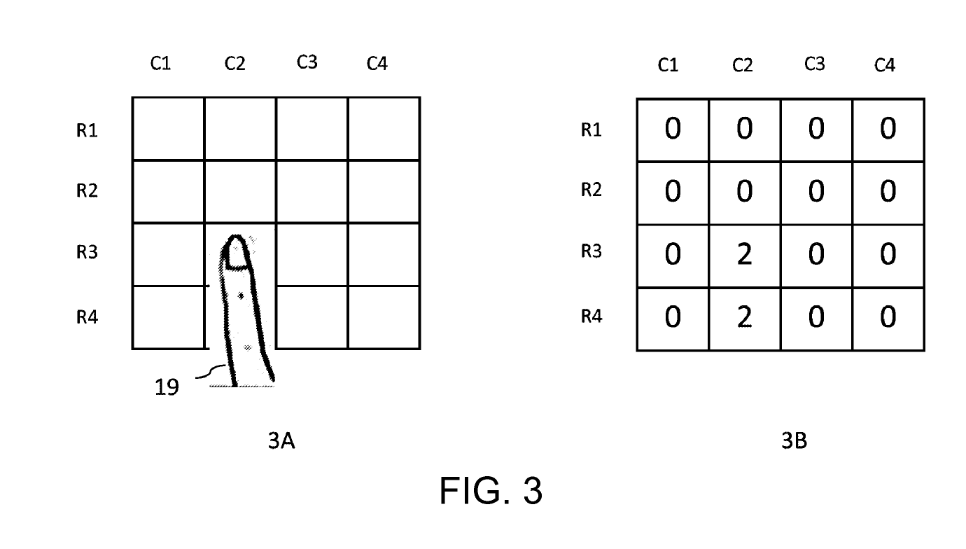

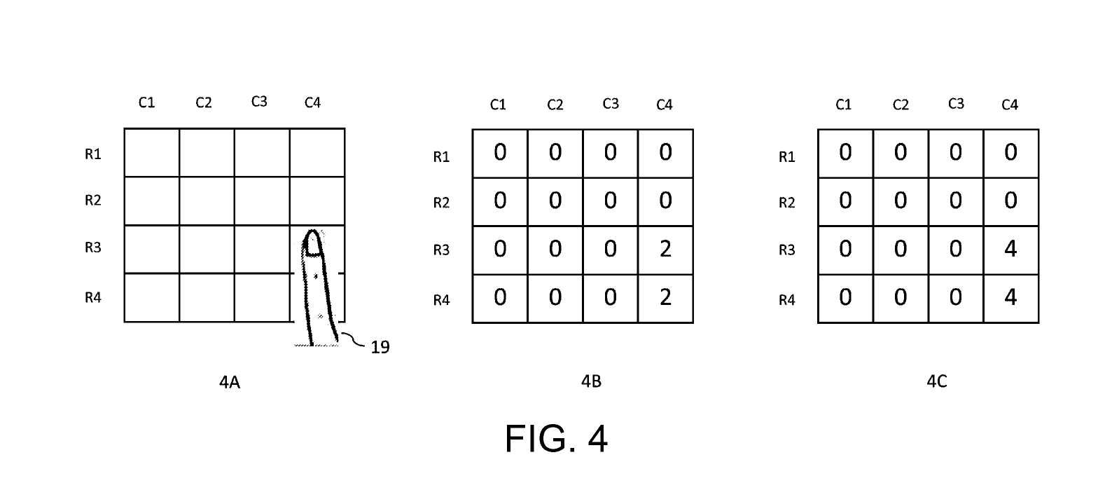

Details of the operating method of an optical input device according to an embodiment of the present invention are to be described below with reference to FIGS. 3 and 4. FIG. 3A shows a schematic diagram illustrating a position of an object in an input detection space when scanning a first frame; FIG. 3B shows a schematic diagram of a process result corresponding to FIG. 3A. FIG. 4A shows a schematic diagram illustrating a position of an object in an input detection space when scanning a second frame; FIG. 4B shows a schematic diagram of a process result corresponding to FIG. 4A; FIG. 4C shows a schematic diagram of another process result corresponding to FIG. 4A.

For better illustrations, in the following example, assume that the input detection space 141 is a 4×4 two-dimensional space, and coordinates with respect to X and Y axes are respectively C1 to C4 and R1 to R4.

Referring to FIG. 3A, it is assumed that the object 19 (a finger) is located at position coordinates (R3, C2) and position coordinates (R4, C2) when the detection beam driven by the scan unit 14 scans the first frame in the input detection space 141. The processing unit 17 may obtain the location signals 151 corresponding to the scan positions through the scan control unit 15 during the scan process of the detection beam. Thus, as the detection beam completes scanning the first frame, the processing unit 17 obtains the corresponding position signals 151 according to the received detection signals 161 and generates a first process result corresponding to the first frame.

In an embodiment of the present invention, while the detection beam driven by the scan unit 14 scans the first frame in the input detection space 141, the detection beam reaching and scanning the position coordinates (R3, C2) is reflected by the finger 19 to generate a reflected detection beam. At this point, the detection unit 16 detects the reflected detection beam, and correspondingly outputs a detection signal 161 to the processing unit 17. After receiving the detection signal 161, the processing unit 17 obtains the corresponding position signal 151 from the scan control unit 15. The corresponding position signal 151 represents the scan position at which the detection beam is reflected, i.e., the position of the finger 19. Similarly, when the detection beam reaches and scans the position coordinates (R4, C2), the detection unit 16 detects the detection beam reflected by the finger 19 and correspondingly outputs a detection signal 161 to the processing unit 17. Likewise, the processing unit 17 obtains the corresponding position signal 151 from the scan control unit 15 after receiving the detection signal 161.

Thus, as the detection beam completes scanning the first frame, the processing unit 17 generates the first process result corresponding to the first frame according to the received detection signals 161 and the corresponding position signals 151. As shown in FIG. 3B, the process result may be a signal-position mapping table. The processing unit 17 may establish a scan position coordinate table for the input detection space 141, and record the corresponding position signals to the scan position coordinate table according to the received detection signals. After completing scanning of one frame, the processing unit 17 is then able to completely generate the signal-position mapping table corresponding to the frame. Taking FIG. 3 for example, reflected detection beams are generated when the detection beam reaches and scans the position coordinates (R3, C2) and (R4, C2), and are detected by the detection unit 16. The detection unit 16 then correspondingly generates the detection signals to the processing unit 17. After receiving the detection signals, the processing unit 17 obtains the position signals corresponding to the detection signals, i.e., the position coordinates (R3, C2) and (R4, C2), and records the corresponding position signals to the scan position coordinate table, as shown in FIG. 3B.

The processing unit 17 may utilize binary values (a bit 1 and a bit 0) to indicate signal values of the position coordinates in the position coordinate table. For example, a bit 0 indicates the that processing unit 17 does not receive the detection signal corresponding to the position coordinates, whereas as a bit 1 indicates that the processing unit 17 receives the detection signal corresponding to the position coordinates.

The processing unit 17 may also indicate the signal values of the position coordinates in the position coordinate table by utilizing intensity values of the received detection signals. As shown in FIG. 3B, the processing unit 17 records a value 2 as the intensity value in the position coordinates (R3, C2) and (R4, C2) corresponding to the received detection signals. For example, the intensity value is a voltage value, a current value, or a comparison value of relative sizes.

Further, the process result may also be a position coordinate set. Taking FIG. 3A for example, after receiving the detection signals, the processing unit 17 obtains the corresponding position signals, i.e., the position coordinates (R3, C2) and (R4, C2), and generates a position coordinate set {(R3, C2) (R4, C2)}. Taking the intensity of detection signals into consideration, the process result may also be a position coordinate-intensity set. Taking FIG. 3A for example, after receiving the detection signals, the processing unit 17 obtains the corresponding position signals, i.e., the position coordinates (R3, C2) and (R4, C2), and generates a position coordinate-intensity set {(R3, C2, 2) (R4, C2, 2)}, which indicates that the intensity value of the received detection signals corresponding to the position coordinates (R3, C2) and (R4, C2) is 2. Similarly, the intensity value may be a voltage value, a current value, or a comparison value of relative sizes.

Referring to FIG. 4, after the first frame is scanned and the processing unit 17 generates the first process result corresponding to the first frame, the detection beam starts scanning the second frame.

Referring to FIG. 4A, assume that the finger 19 slides to the position coordinates (R3, C4) and the position coordinates (R4, C4) when the detection beam driven by the scan unit 14 scans the second frame in the input detection space 141. Similarly, when the detection beam driven by the scan unit 14 scans the second frame in the input detection space 141, the detection beam reaching and scanning the position coordinates (R3, C4) is reflected to generate a reflected detection beam. At this point, the detection unit 16 detects the reflected detection beam, and correspondingly outputs a detection signal 161 to the processing unit 17. After receiving the detection signal 161, the processing unit 17 obtains the corresponding position signal 151 from the scan control unit 15. Likewise, the detection beam reaching and scanning the position coordinates (R4, C4) is reflected by the finger 19 to generate a reflected detection beam. The detection unit 16 detects the reflected detection beam, and correspondingly outputs a detection signal 161 to the processing unit 17. After receiving the detection signal 161, the processing unit 17 also obtains the corresponding position signal 151 from the scan control unit 15.

As such, after the detection beam completes scanning the second frame, the processing unit 17 generates a second process result corresponding to the second frame according to the received detection signals 161 and the corresponding position signals 151. In the embodiment in FIG. 4B, the second process result is a signal-position mapping table, and the intensity value of the received signals indicate the signal values of the position coordinates in the position coordinate table, with the intensity value being 2. Similarly to previous descriptions, the process result may also be implemented by different methods, and associated details shall be omitted herein.

Next, the processing unit 17 determines that the finger 19 moves from the position at the position coordinates (R3, C2) and (R4, C2) to the position of the position coordinates (R3, C4) and (R4, C4) according to the first process result corresponding to the first frame and the second process result corresponding to the second frame, indicating that the finger 19 is performing a sliding movement. Thus, the processing unit 17 generates an operation instruction 171 of a finger slide according to the first and second process results. The processing unit 17 then sends the operation instruction 171 of a finger slide to the peripheral device 18, e.g., a computer. In an example of browsing through photographs, assuming that the finger slide movement corresponds to a page change operation instruction of photograph browsing, the computer executes the page change operation of photograph browsing after receiving the operation instruction 171.

In the operating method of an optical input device according to an embodiment of the present invention, in addition to determining two-dimensional movements of an object, the processing unit 17 is also capable of determining three-dimensional movements of an object according to the intensity value of received detection signals. FIG. 4C shows a schematic diagram of another process result corresponding to FIG. 4A. In the embodiment in FIG. 4C, the second process result is a signal-position mapping table, and the intensity value of the received detection signals indicates the signal value of the position coordinates in the position coordinate table, with the intensity value being 4.

When the processing unit 17 determines the movement of the finger 19 according to the first process result corresponding to the first frame and the second process result corresponding to the second frame, the processing unit 17 determines that the finger 19 moves from the position at the position coordinates (R3, C2) and (R4, C2) to the position at the position coordinates (R3, C4) and (R4, C4). In addition, since the intensity value 4 of the detection signals of the second process result corresponding to the second frame is greater than the intensity value 2 of the detection signals of the first process result corresponding to the first frame, the processing unit 17 further determines that the finger 19 moves towards the optical input device 10. Thus, the processing unit 17 generates a corresponding operation instruction 171 according to the three-dimensional movement of the finger 19, and sends the operation instruction 171 to the peripheral device 18 to perform operation control on the peripheral device 18. By determining three-dimensional movements of an object in the input detection space, the optical input device 10 offers a greater number of operation instructions for controlling the peripheral device utilizing more operation modes.

In the above embodiment, the processing unit 17 determines the movement of the object 19 according to the process results corresponding to the first and second frames, and generates the corresponding operation instruction 171. In an alternative embodiment, the processing unit 17 may also determine the movement of the object 19 according to process results corresponding to more than two frames and then generate the corresponding operation instruction. In general, the accuracy of the determination result gets higher as the number of frames based on which the process results are obtained gets larger, and so the accuracy of the operation instruction 171 generated by the processing unit 17 is also increased.

According to the optical input device and the operating method of the optical input device, a detection beam reflected from an input detection space can be detected to generate process results corresponding to different scan frames, and a movement of an object can be determined according to the process results of the different frames to generate a corresponding operation instruction for controlling an operation of a peripheral device. Therefore, the optical input device and the operating method of the optical input device are capable of enhancing versatility of user operations on a peripheral device.

Further, according to the optical input device and the operating method of the optical input device, without going through complicated image recognition processing, process results corresponding to different scan frames can be generated after detecting a detection beam reflected from an input detection space, thereby effectively reducing an operation response time and significantly increasing operation instantaneity.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A operating method of an optical input device, comprising:
driving a detection beam to scan a plurality of frames in an input detection space;
when scanning a first frame, detecting a first reflected detection beam and correspondingly outputting a first detection signal, and generating a first process result according to the first detection signal;
when scanning a second frame, detecting a second reflected detection beam and correspondingly outputting a second detection signal, and generating a second process result according to the second detection signal;
generating an operation instruction according to the first process result and the second process result; and
outputting the operation instruction to a peripheral device to execute the operation instruction.

2. The method according to claim 1, further comprising:
when scanning the first frame, obtaining a first position signal corresponding to the first detection signal, and generating the first process result according to the first detection signal and the first position signal; and
when scanning the second frame, obtaining a second position signal corresponding to the second detection signal, and generating the second process result according to the second detection signal and the second position signal.

3. The method according to claim 1, wherein the first process result and the second process result are signal-position mapping tables, position coordinate sets or position coordinate-intensity sets.

4. The method according to claim 1, wherein the first process result includes a first scan position corresponding to the first detection signal, and the second process result includes a second scan position corresponding to the second detection signal.

5. The method according to claim 4, wherein the first process result further includes a first signal intensity value corresponding to the first detection signal, and the second process result further includes a second signal intensity value corresponding to the second detection signal.

6. An optical input device, comprising:
an light source module, for generating a detection beam;
a scan unit, for driving the detection beam to scan a plurality of frames in an input detection space;
a detection unit, for detecting the detection beam reflected by an object located in the input detection space when scanning at least two frames of the frames, and correspondingly outputting a detection signal; and
a processing unit, for generating a process result respectively corresponding to the at least two frames according to the detection signal when scanning the at least two frames of the frames, generating an operation instruction according to the process results corresponding to the at least two frames, and outputting the operation instruction to a peripheral device to execute the operation instruction.

7. The optical input device according to claim 6, further comprising:
a scan control unit, for outputting a position signal corresponding to the detection signal to the processing unit when scanning the frames.

8. The optical input device according to claim 6, wherein the process result is a signal-position mapping table, a position coordinate set or a position coordinate-intensity set.

9. The optical input device according to claim 6, wherein the process result includes a scan position corresponding to the detection signal.

10. The optical input device according to claim 6, wherein the process result includes a signal intensity value corresponding to the detection signal.
